(19) United States
(12) Patent Application Publication
(10) Pub. No.: US 2023/0087337 A1
(43) Pub. Date: Mar. 23, 2023

(54) INFORMATION PROCESSING APPARATUS, INFORMATION PROCESSING METHOD AND NON-TRANSITORY COMPUTER READABLE RECORDING MEDIUM

(71) Applicant: CASIO COMPUTER CO., LTD., Tokyo (JP)

(72) Inventors: Hiromi KAMEYAMA, Tokyo (JP); Satoshi HIGASHIBEPPU, Tokyo (JP)

(73) Assignee: CASIO COMPUTER CO., LTD., Tokyo (JP)

(21) Appl. No.: 17/897,128

(22) Filed: Aug. 27, 2022

(30) Foreign Application Priority Data
Sep. 22, 2021 (JP) 2021-154102

(51) Int. Cl. G06F 30/12

(52) U.S. Cl. CPC G06F 30/12; G06F 2111/16

(57) ABSTRACT

Provided are an information processing apparatus, an information processing method and a non-transitory computer readable recording medium making it possible to display more appropriate reference designs.

A processing unit of the information processing apparatus acquires design data which pertains to a target design of an article which has a plurality of components, executes an extraction process of extracting at least one reference design from a plurality of reference designs of the article which is generated in advance on the basis of design data, makes a display unit display information pertaining to the at least one reference design which is extracted by the extraction process, and in the extraction process, derives a component similarity value which indicates a degree of similarity between each of some of or all reference designs in the plurality of reference designs and a target design for each of the plurality of components, derives a first index value on the basis of a plurality of component similarity values which consist of the component similarity values which are derived for each of the plurality of components, and extracts at least one reference design from the plurality of reference designs on the basis of the derived first index value.

### BACKGROUND OF THE INVENTION

### Technical Field

The present invention relates to an information processing apparatus, an information processing method and a non-transitory computer-readable recording medium.

### Background Art

Nowadays, there is known a technology of making it possible for a user to customize a design of an article in a case of purchasing the article which is a product on an EC (an electronic commerce) site which is described in Japanese Patent No. 6034448 or Japanese Patent No. 6709308. In addition, there is proposed a technology of making designs that other users who have attributes and preferences in common with the user create display as reference designs for assisting in conceiving a design by the user.

### BRIEF SUMMARY OF THE INVENTION

In order to solve the above issue, according to the first aspect of the present invention, there is provided an information processing apparatus which includes a processing unit, in which the processing unit acquires design data which pertains to a target design of an article which has a plurality of components, executes an extraction process of extracting at least one reference design from a plurality of reference designs of the article on the basis of the design data,

makes a display unit display information pertaining to at least the one reference design which is extracted by the extraction process, and

in the extraction process,

derives a component similarity value which indicates a degree of similarity between each of some or all reference designs in the plurality of reference designs and the target design in regards to each of the plurality of components,

derives a first index value on the basis of a plurality of component similarity values which consist of the component similarity values which are derived in regards to each of the plurality of components, and

extracts the at least one reference design from the plurality of reference designs on the basis of the derived first index value.

In addition, in order to solve the above issue, according to the second aspect of the present invention, there is also provided an information processing method which is executed by a computer of an information processing apparatus including

acquiring design data which pertains to a target design of an article which has a plurality of components,

executing an extraction process of extracting at least one reference design from a plurality of reference designs of the article on the basis of the design data, and

making a display unit display information which pertains to at least one reference design which is extracted by the extraction process,

in the extraction process

deriving a component similarity value which indicates a degree of similarity between each of some or all reference designs in the plurality of reference designs and the target design for each of the plurality of components,

deriving a first index value on the basis of a plurality of component similarity values which consist of the component similarity values which are derived for each of the plurality of components, and

extracting the at least one reference design from the plurality of reference designs on the basis of the derived first index value.

In addition, in order to solve the above issue, according to the third aspect of the present invention, there is further provided a non-transitory computer-readable recording medium for recording a program for making a computer of an information processing apparatus realize functions of

acquiring design data which pertains to a target design of an article which has a plurality of components,

executing an extraction process of extracting at least one reference design from a plurality of the reference designs of the article on the basis of the design data, and

making a display unit display information which pertains to the at least one reference design which is extracted by the extraction process,

in the extraction process

deriving a component similarity value which indicates a degree of similarity between each of some or all reference designs in the plurality of reference designs and the target design for each of the plurality of components,

deriving a first index value on the basis of a plurality of component similarity values which consist of the component similarity values which are derived for each of the plurality of components, and

extracting the at least one reference design from the plurality of reference designs on the basis of the derived first index value.

### BRIEF DESCRIPTION OF THE SEVERAL VIEWS OF THE DRAWING

FIG. 1 is a diagram illustrating one example of an information processing system according to one embodiment of the present invention.

FIG. 2 is a block diagram illustrating one example of a functional configuration of a server.

FIG. 3 is a diagram illustrating one example of contents of user data.

FIG. 4 is a block diagram illustrating one example of a functional configuration of a terminal device.

FIG. 5 is a diagram illustrating one example of a design screen.

FIG. 6 is a diagram illustrating one example of contents of user design data.

FIG. 7 is a diagram illustrating one example of contents of component similarity value data.

FIG. 8 is a diagram illustrating one example of contents of weighted data.

FIG. 9 is a diagram illustrating another example of the contents of the weighted data.

FIG. 10 is a diagram illustrating one example for explaining a reference design extraction procedure in a first extraction method.

FIG. 11 is a diagram illustrating one example of contents of second index value data.

FIG. 12 is a diagram illustrating one example for explaining a reference design extraction procedure in a second extraction method.

FIG. 13 is a diagram illustrating one example for explaining a reference design extraction procedure in a third extraction method.

FIG. 14 is a flowchart illustrating one example of a control procedure of design processing.

FIG. 15 is a flowchart illustrating one example of a control procedure of a reference design extraction process.

FIG. 16 is a flowchart illustrating one example of a control procedure of a process of deciding reference designs to be extracted in a case of using the first extracting method.

FIG. 17 is a flowchart illustrating one example of a control procedure of a process of deciding reference designs to be extracted in a case of using the second extracting method.

FIG. 18 is a flowchart illustrating one example of a control procedure of a process of deciding reference designs to be extracted in a case of using the third extracting method.

### DETAILED DESCRIPTION OF THE INVENTION

In the following, one embodiment of the present invention will be described on the basis of the drawings.

<Configuration of Information Processing System>

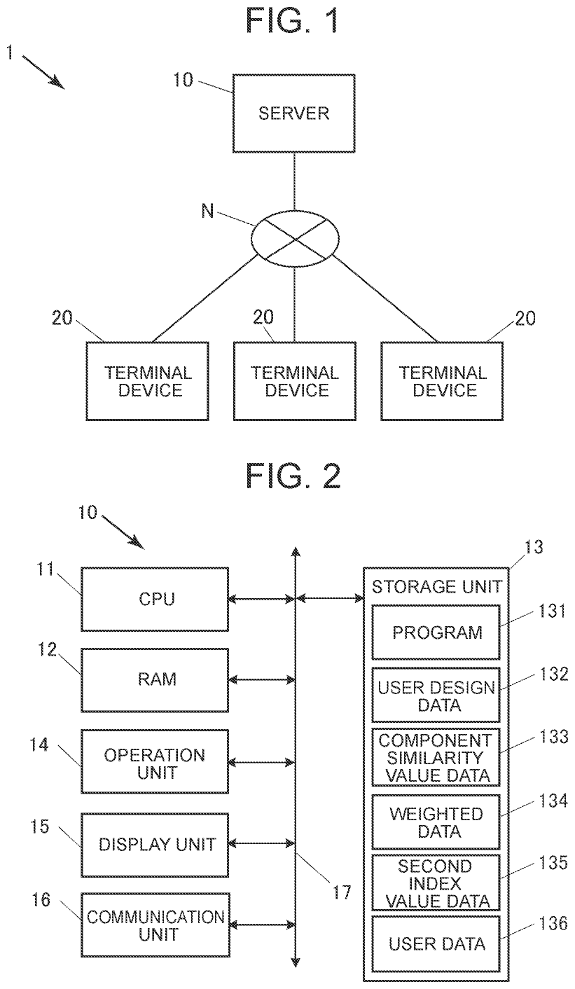

FIG. 1 is a diagram illustrating one example of an information processing system 1 according to one embodiment of the present invention.

The information processing system 1 includes a server 10 (an information processing apparatus) and a plurality of terminal devices 20. The server 10 and the plurality of terminal devices 20 are mutually connected over a communication network N and therefore mutual data transmission and reception is possible for the server 10 and the terminal devices 20. Although the communication network N is, for example, the Internet, other networks such as a LAN (Local Area Network) and so forth may be used, not limited to the Internet. Wireless communication paths may be included as a communication path between the server 10 and the communication network N and as a communication path between each terminal device 20 and the communication network N.

The plurality of terminal devices 20 is used by mutually different users. Each terminal device 20 may be either a portable-type device or a stationary-type device and is, for example, a smartphone, a tablet terminal, a PC (Personal Computer) and so forth.

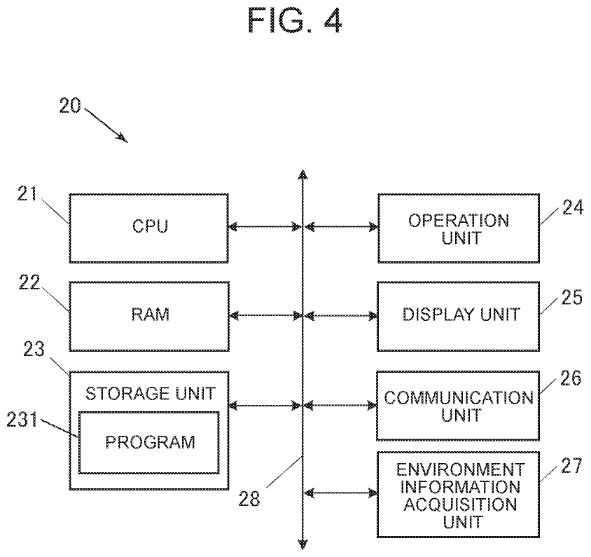

The server 10 executes various processes in accordance with a request from any one of the terminal devices 20 (hereinafter, referred to as the terminal device 20) transmits a result of execution of the processes to the terminal device 20 and makes a display unit 25 (see FIG. 4) of the terminal device 20 display a screen which pertains to the result of execution of the processes. The information processing system 1 provides the user of the terminal device 20 of an e-commerce service through a series of these operations which is performed between the server 10 and the terminal device 20. It is possible for the user of the terminal device 20 to log in the e-commerce service and to purchase an article, that is, a product by operating the terminal device 20. In addition, in the e-commerce service, it is possible for the user to customize the design of the article to be purchased by himself/herself. Customization of the design of each article will be described later in detail.

<Configuration of the Server>

FIG. 2 is a block diagram illustrating one example of a functional configuration of the server 10.

The server 10 includes a CPU (Central Processing Unit) 11, a RAM (Random Access Memory) 12, a storage unit 13, an operation unit 14, a display unit 15, a communication unit 16, a bus 17 and so forth. The respective units of the server 10 are mutually connected via the bus 17.

The CPU 11 is a processor which controls operations of respective units of the server 10 by reading out and executing a program 131 which is stored in the storage unit 13 and performing various arithmetic processing. In one embodiment, the CPU 11 corresponds to a “processing unit”. Incidentally, the processing unit may have a plurality of processors (for example, a plurality of CPUs) and the plurality of processors may execute a plurality of processes in design processing that the CPU 11 in one embodiment executes. In this case, the plurality of processors corresponds to the “processing unit”. In this case, the plurality of processors may be involved in execution of a common process or the plurality of processors may execute mutually different processes in parallel with one another independently of one another.

The RAM 12 provides the CPU 11 a memory space for working and stores data in the memory space temporarily.

The storage unit 13 is a non-transitory recording medium which is readable by the CPU 11 which functions as a computer and stores the program 131 and various kinds of data. The storage unit 13 includes a nonvolatile memory such as, for example, a flash memory and so forth. The program 131 is stored in the storage unit 13 in the form of a computer-readable program code. User design data 132, component similarity value data 133, weighted data 134, second index value data 135, user data 136 and so forth are present as data to be stored into the storage unit 13. The user design data 132 contains a plurality of pieces of design data which pertains to the design of the article which is customized by the user. The component similarity value data 133, the weighted data 134 and the second index value data 135 are referred to in a case of presenting reference designs to the user and details of the data 133, 134 and 135 will be described later.

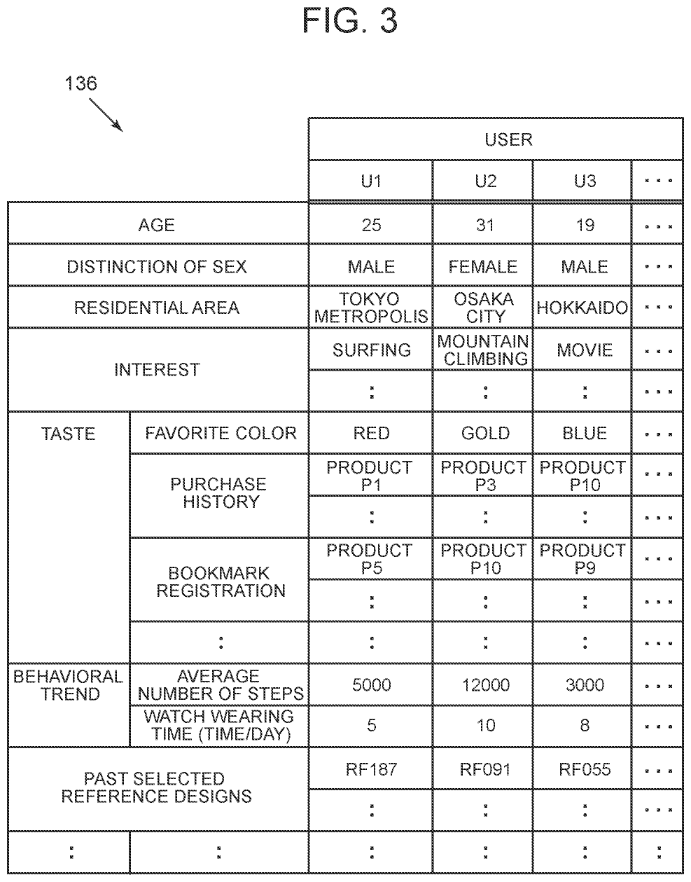

FIG. 3 is a diagram illustrating one example of contents of the user data 136.

Information on data items which pertain to an attribute and a characteristic of each of a plurality of users U (users U1, U2, U3, . . . ) who utilizes the e-commerce service is registered in the user data 136. In the above information, the attribute of the user U contains items “Age”, “Distinction of Sex” and “Residence Place”. However, the attribute of each user U may not contain some of these items and may contain items other than these items. In addition, the characteristic of the user U contains items “Interest”, “Taste”, “Behavioral Trend” and “Past Selected Reference Designs”. However, the characteristic of the user U may not contain some of these items and may include items other than these items.

In the example which is illustrated in FIG. 3, items “Favorite Color”, “Purchase History” and “Bookmark Registration” are contained as the taste of the user U. However, the items to be contained in the taste of the user U are not limited to these items.

For example, a color which is designated by an inputting operation that the user U perform is registered into the item “Favorite Color”. As an alternative, a favorite color of the user U may be estimated on the basis of the user's past purchase history tendency and so forth of the user U and the estimated color may be registered into the item “Favorite Color”.

The item “Purchase History” indicates products that the user U has purchased in the past via the e-commerce service.

The item “Bookmark Registration” indicates products that the user U registers as the favorite products via the e-commerce service.

Either concrete products or general names of the products concerned may be registered into the items “Purchase History” and “Bookmark Registration”.

In addition, in the example which is illustrated in FIG. 3, items “Average Number Of Steps” and “Watch Wearing Time” are contained as the behavioral trend of the user U. However, items to be contained in the item “Behavioral Trend” of the user U are not limited to the above two items.

The item “Average Number Of Steps” indicates an average number of steps per day which is counted by a smartphone that the user U has, an electronic wristwatch that the user U wears and so forth. For example, in a case where the terminal device 20 is the smartphone, data on the number of steps which is counted by the terminal device 20 and is transmitted to the server 10 may be used. In addition, in a case where the terminal device 20 is the smartphone and the user U wears the electronic wristwatch which is connected to communicate with that smartphone, data on the number of steps which is counted by that electronic wristwatch and is transmitted to the server 10 via the smartphone may be used. In a device which measures the number of steps (the terminal device 20, the electronic wristwatch or the like), motion sensors which detect a motion state of the device such as, for example, an acceleration sensor, an angular velocity sensor, a geomagnetism sensor and so forth are installed and the number of steps is measured on the basis of results of detection by these motion sensors.

The item “Watch Wearing Time” indicates a day-based average wearing time of the above electronic wristwatch. The item “Watch Wearing Time” is automatically detected by, for example, a detection mechanism that the electronic wristwatch has and a result of detection is transmitted to the server 10 via the smartphone which functions as the terminal device 20.

Again in FIG. 2, the operation unit 14 has a pointing device such as a mouse and so forth and a keyboard and so forth, accepts position input, key input and so forth which are performed by an operator of the server 10 and outputs operation information on the position input, the key input and so forth to the CPU 11.

The display unit 15 includes a display such as a liquid crystal display and so forth and performs various displaying operations on the display in accordance with a display control signal which is sent from the CPU 11.

The communication unit 16 performs a communication operation which follows a communication standard which is set in advance. The communication unit 16 performs that communication operation and thereby performs data transmission and reception to and from each terminal device 20 over the communication network N.

<Configuration of the Terminal Device>

FIG. 4 is a block diagram illustrating one example of a functional configuration of the terminal device 20.

The terminal device 20 includes a CPU 21, a RAM 22, a storage unit 23, an operation unit 24, the display unit 25, a communication unit 26, an environment information acquisition unit 27, a bus 28 and so forth. These respective units 21 to 27 of the terminal device 20 are mutually connected via the bus 28.

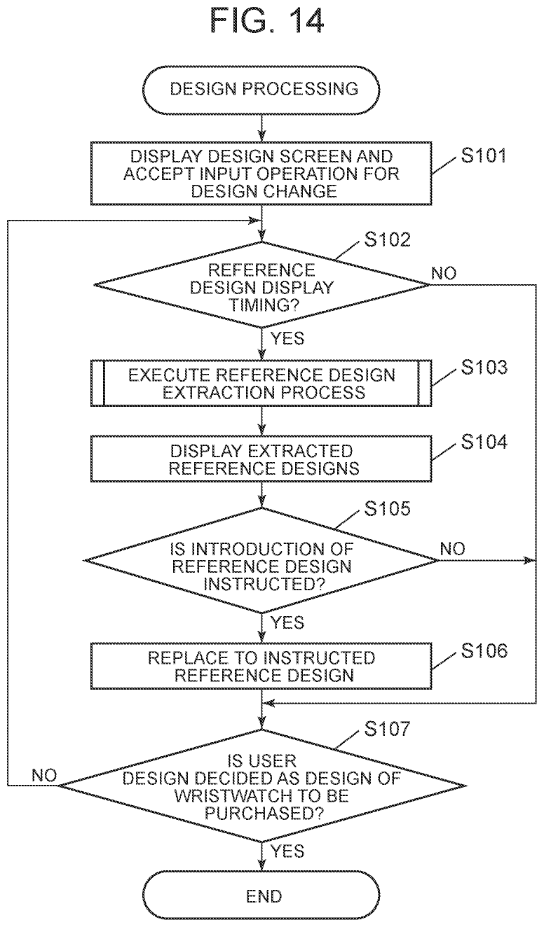

The CPU 21 is a processor which controls operations of the respective units of the terminal device 20 by reading out and executing a program 231 which is stored in the storage unit 23 and performing various arithmetic processing in accordance with that program. Incidentally, each terminal device 20 may have a plurality of processors (for example, a plurality of CPUs) and that plurality of processors may execute a plurality of processes in design processing (FIG. 14) that the CPU 21 in one embodiment of the present invention executes. In this case, the plurality of processors may either involve in execution of a process which is common among the processors or may execute different processes independently of one another, in parallel with one another.

The RAM 22 provides the CPU 21 of a working memory space and stores data temporarily.

The storage unit 23 is a non-transitory recording medium which is readable by the CPU 21 which functions as a computer and stores a program 231 and various kinds of data. The storage unit 23 includes a nonvolatile memory such as, for example, a flash memory and so forth. The program 231 is stored in the storage unit 23 in the form of a computer-readable program code. For example, a web browser is contained in the program 231. In a case where the Web browser is executed in the terminal device 20, it becomes possible to gain access to a Web site of the e-commerce service that the information processing system 1 provides on that Web browser. On the Web browser which gains access to that Web site, results of execution of processing of various processes which pertain to the e-commerce service that the server 10 executes in accordance with an inputting operation by the user are displayed. For example, it becomes possible for the user U who uses that terminal device 20 to purchase an article which is displayed as a product and to customize a design of the article which will be described later on the Web browser. Incidentally, a dedicated application program which is used for execution of the various processes which pertains to the e-commerce service may be used in place of a general-purpose Web browser.

The operation unit 24 has at least one of input devices such as a pointing device such as a mouse and so forth, a keyboard, a touch panel and so forth, accepts the inputting operation which is performed by the user U on the input device and outputs information on that inputting operation to the CPU 21.

The display unit 25 includes a display such as a liquid crystal display and so forth and performs various displaying operations on the display in accordance with a display control signal which is sent from the CPU 21.

The communication unit 26 performs a communication operation which follows a communication standard which is set in advance. The communication unit 26 performs data transmission and reception to and from the server 10 over the communication network N by performing this communication operation.

The environment information acquisition unit 27 acquires information which pertains to the surrounding environment of the terminal device 20 (the surrounding environment of the user U of the terminal device 20) and outputs the acquired information to the CPU 21. The environment information acquisition unit 27 includes at least one device which is adapted to acquire information which pertains to, for example, a current position of the terminal device 20, a temperature or other meteorological conditions (a humidity, a barometric pressure and so forth) and so forth. The environment information acquisition unit 27 may have, for example, a module (a satellite radio-wave reception processing unit) which receives radio waves which are transmitted from a positioning satellite of GNSS (Global Navigation Satellite System) and calculates the current position of the terminal device 20 and the date and time that the terminal device 20 is used as a device for acquiring the information on the current position of the terminal device 20. Although there is no particular limitation on the GNSS to be used, a Quasi-Zenith Satellite System which uses, for example, GPS (Global Positioning System), GLONASS (Global Navigation Satellite System), Quasi-Zenith Satellite System which is called “Michibiki” and so forth may be used. In addition, the environment information acquisition unit 27 may have, for example, a thermometer as a device for acquiring information on the temperature.

<Operation of the Information Processing System>

Next, operations of the information processing system 1 will be described with a focus on operations which relate to customization of the design of the article. In one embodiment, the description will be made by using an example that the user U purchases a wristwatch as the article, that is, the product by customizing the design of that wristwatch.

It becomes possible for the user U to log-in the e-commerce service by launching the Web browser on the terminal device 20 that the user himself/herself uses, gaining access to the Web site of the e-commerce service and then inputting predetermined authentication information into the Web site. Although there is no particular limitation on a concrete procedure of login-related processing, a procedure that, for example, in a case where the server 10 receives the user ID and the user's password that the user U inputs using the terminal device 20 and the received password matches a password which is registered in advance in one-to-one correspondence with the user ID as authentication data, the server 10 starts a login session may be adopted.

In a case where the user U wishes to purchase the wristwatch by customizing the design of the wristwatch, the user U makes the display unit 25 of the terminal device 20 display a design screen 30 which is used for generating design data which pertains to the design of the wristwatch on the Web browser. Describing in more detail, in a case where the user U performs an operation for calling the design screen in a state of gaining access to the Web site of the e-commerce service on the Web browser, a request for displaying the design screen is transmitted to the server 10 from the terminal device 20. The server 10 receives the request for displaying the design screen, then generates screen configuration data which is used for configuring the design screen and transmits the generated screen configuration data to the terminal device 20. The terminal device 20 makes the display unit 25 display the design screen in accordance with the received screen configuration data.

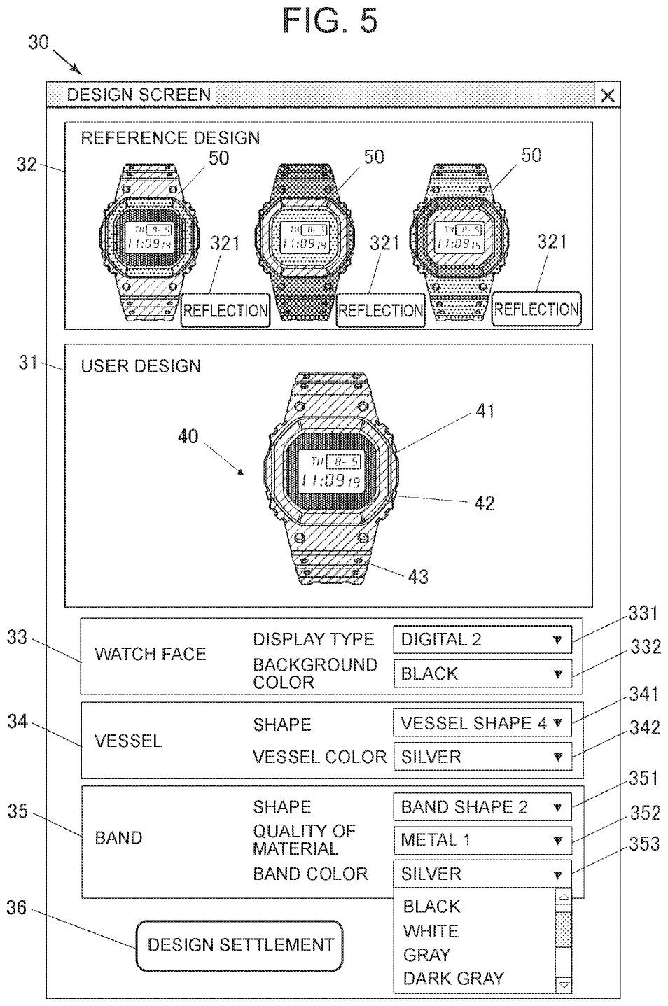

FIG. 5 is a diagram illustrating one example of the design screen 30.

The design screen 30 includes a user design display area 31, a reference design display area 32, component design areas 33, 34 and 35 and a design settlement button 36. Reflection buttons 321 which are installed in the reference design display area 32 and drop-down lists 331, 332, 341, 342, 351, 352 and 353 which are installed in the component design areas 33, 34 and 35 respectively are operation target elements that user operations are to be performed. In a case where the user operations (for example, an operation of touching the touch panel, an operation of clicking the mouse in a state of placing a mouse cursor over the area concerned and so forth) are performed, a processing request which accords with the user operation is transmitted from the terminal device 20 to the server 10. The server 10 executes a process which accords with the processing request, makes the storage unit 13 store a result of execution of the process, transmits image configuration data on the design screen 30 that the result of execution of the process is reflected to the terminal device 20 and makes the display unit 25 update contents which are displayed on the design screen 30.

Designs (a user design, target designs) that the user U customizes are displayed in the user design display area 31 as an image of a wristwatch 40. More specifically, one user design that designs of components are customized in accordance with the user operations in the component design areas 33, 34 and 35 and which is obtained at that point in time is displayed in the user design display area 31. In one embodiment, customization of the design of the wristwatch 40 is performed in such a manner that, first, the model of the wristwatch 40 is selected and then parts (designs of components) of the basic design of that model are changed sequentially. Accordingly, the user design contains information on the model.

A predetermined number of reference designs which relates to the user design which is obtained at that point in time is displayed as images of a wristwatch 50 in the reference design display area 32 for assistance of conceiving of an optional design by the user U. Viewing from another standpoint, the reference designs are model designs which would become fine examples of the design that the user U conceives. Although three reference designs are displayed in the reference design display area 32 in the example in FIG. 5, the number of the reference designs to be displayed is not limited to three and the number of the reference designs may be less than two or more than four. The reference designs are prepared in advance by a creator, a designer and others and are stored in the storage unit 13 of the server 10. AS an alternative, user designs which are created by other users U may be used as the reference designs. Also, the reference models correspond to designs which are created by changing the basic design of a certain model of the wristwatch 40 and contain information on the model, similarly to the user design. In other words, the user design and the reference designs are designs which pertain to any one a plurality of models of the wristwatch 40. The reference designs which are displayed in the reference design display area 32 may be replaced with other designs in accordance with a user design which is obtained after design changing every time that the user design which is displayed in the reference design display area 31 is changed. As an alternative, reference designs which accord with the user design which is obtained at that point in time may be displayed by triggering an instruction to display the reference designs which is issued from the user U.

Reflection buttons 321 are displayed respectively in the vicinities of three reference designs. In a case where an operation of selecting one reflection button 321 is performed, the contents of one reference design which corresponds to the selected reflection button 321 are reflected on the user design which is displayed in the user design display area 31. That is, the contents of the user design are replaced with the contents of the reference design which is selected. After replacing the contents, it becomes also possible to further customize the design of each component by using the component design areas 33, 34 and 35. In a case where one reference design is selected by using one reflection button 321, the reference design ID of the selected reference design is registered into the data item “Past Selected Reference Designs” of the user data 136. Incidentally, in place of an aspect that the entire of the selected reference design is reflected on the user design, it may become possible to reflect part of the selected reference design (for example, per component) on the user design. In addition, in place of the reflection buttons 321, the above-mentioned operation which is performed when operating one reflection button 321 may be performed by an operation of selecting one image of the wristwatch 50 which is displayed as one reference design. In this case, display of the reflection buttons 321 may be omitted.

The component design areas 33, 34 and 35 are areas where setting contents of designs of the components of the wristwatch 40 are displayed and are also areas where an inputting operation for changing the design of each component is accepted. In one embodiment, the wristwatch 40 has three design changeable components. These three components are a watch face 41, a vessel 42 and a band 43. The component design areas 33, 34 and 35 correspond to the watch face 41, the vessel 42 and the band 43 respectively. However, this correspondence is illustrative and the design of an optional component which configures the wristwatch 40 may be made changeable and designs of two or less components or four or more components may be made changeable. In these cases, each component design area may be prepared for each component which is made changeable in design.

The watch face 41 is a part where information on the time and so forth is displayed in the wristwatch 40. The watch face 41 includes a digital display part in a case where the wristwatch 40 is a digital-system wristwatch and includes hands and a dial in a case where the wristwatch 40 is an analog-system wristwatch. The vessel 42 is a frame-shaped member which surrounds the watch face 41. The band 43 is a belt-like member which is wound on the user's wrist in a case of wearing the wristwatch 40 on the wrist. The component design area 33 is used for setting the design of the watch face 41. The component design area 34 is used for setting the design of the vessel 42. The component design area 35 is used for setting the design of the band 43.

In one embodiment, each of the above-described components whose designs are changeable includes a plurality of design elements. In addition, each of the dropdown lists 331, 332, 341, 342, 351, 352 and 353 which are set in the component design areas 33, 34 and 35 corresponds to one design element of one corresponding component. It becomes possible to display a plurality of candidates which indicates setting contents (contents of designs) of the design elements by selecting one of the drop-down lists 331, 332, 341, 342, 351, 352 and 351. In a case where any one of the candidates is selected, the setting contents of that design element are changed to contents of the selected candidate.

The watch face 41 includes items “Display Type” and “Background Color” as the design elements. “Display Type” is the design element which designates a combination of the display system (the analog-system or the digital-system) with the kind of the basic design in each display system. “Background Color” is the design element which designates the color of a background area of a digital display part or the dial. The dropdown lists 331 and 332 in the component design area 33 correspond to items “Display Type” and “Background Color” respectively. The design of the watch face 41 is decided depending on the combination of the setting contents on the dropdown lists 331 and 332.

The vessel 42 includes items “Shape” and “Vessel Color” as the design elements. “Shape” is the design element which designates the combination of designs such as the shape, decorations and so forth of the vessel 42. “Vessel Color” is the design element which designates the color of the vessel 42. The dropdown lists 341 and 342 in the component design area 34 correspond to “Shape” and “Vessel Color” respectively. The design of the vessel 42 is decided depending on the combination of the setting contents on the dropdown lists 341 and 342.

The band 43 contains items “Shape”, “Quality of Material” and “Band Color” as the design elements. “Shape” is the design element which designates the combination of designs of the shape, decorations and so forth of the band 43. “Quality of Material” is the design element which designates the quality of material of the band 43. “Band Color” is the design element which designates the color of the band. The dropdown lists 351, 352 and 353 in the component design area 35 correspond to “Shape”, “Quality of Material” and “Band Color” respectively. The design of the band 43 is decided depending on the combination of the setting contents on the dropdown lists 351, 352 and 353.

At a point in time that customization of designs is started, the design elements of the basic design (an initialized design) of the model that the user U selects are reflected on the setting contents on the dropdown lists 331, 332, 341, 342, 351, 352 and 353. In a case where a design element which is different from the design element of the basic design is selected and decided by performing an operation on any one of these dropdown lists, the design of the component concerned is changed and the design of the wristwatch 40 is changed depending on design changing of that component. Design changing of the wristwatch 40 is reflected on the user design in the user design display area 31.

Incidentally, all the components may not necessarily have the plurality of design elements. The designs of at least some components may be defined depending on a single design element.

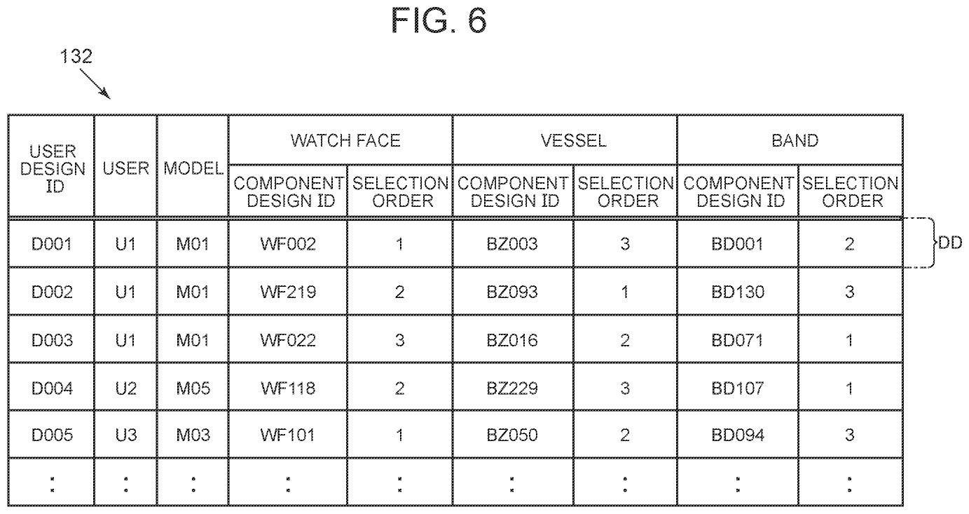

In a case where an operation of selecting the design settlement button 36 is performed, the user design of the wristwatch 40 which is obtained at the point in time that design settlement button 36 is selected is settled and design data DD (see FIG. 6) which pertains to the settled user design is stored into the user design data 132. In addition, also design data DD which pertains to a user design which is in an on-going status before the design settlement button 36 is operated is stored into the user design data 132. For example, every time that the design of each component is changed in the component design area 33, 34 or 35, the design data DD which pertains to the user design which is in the on-going status is stored into the user design data 132.

FIG. 6 is a diagram illustrating one example of contents of the user design data 132.

In the table of the user design data 132 in FIG. 6, each data row corresponds to the design data DD which pertains to one user design (a completed design or a design which is in the on-going status). Each piece of the design data DD contains data items “User Design ID”, “User” and “Model” and component data which pertains to each of the items “Watch Face”, “Vessel” and “Band”. The component data which pertains to each of the items “Watch Face”, “Vessel” and “Band” contains data items “Component Design ID” and “Selection Order”.

The data item “User Design ID” indicates unique codes which are respectively assigned to user designs in the relevant design data DD. It becomes possible to specify one user design on the basis of “User Design ID”.

The data item “User” indicates the users U who respectively correspond to user designs in the relevant design data DD.

The data item “Model” indicates models which respectively correspond to the user designs in the relevant design data DD.

The data item “Component Design ID” indicates codes which respectively indicate the contents of the designs of the relevant components. For example, a code which is defined for each combination of the setting contents on the dropdown lists 331 and 332 is registered in “Component Design ID” of “Watch Face”. It becomes possible to specify one combination of the setting contents on the dropdown lists 331 and 332, that is, the contents of each design of the watch face 41 from “Component Design ID”. The same thing also applies to codes of the items “Component Design” in the items “Vessel” and “Band”.

The data item “Selection Order” indicates the order that each of the watch face 41, the vessel 42 and the band 43 is selected for design decision (the order that operations for selecting the dropdown lists 331 and 332 in the component design area are performed) after the start of customization of the user design on the design screen 30. For example, in regards to the user design that “User Design ID” in FIG. 6 is “D001”, “Selection Order” of “Watch Face” is set to “1”, “Selectin Order” of “Vessel” is set to “3” and “Selection Order” of “Band” is set to “2”. Therefore, this state indicates that the components are selected in the order of the watch face 42, the band 43 and the vessel 42 in customization of the user design. The item “Selection Order” is used for generation of the weighted data 134 which will be described later.

Incidentally, there are cases where the list of the setting contents is displayed by selecting the dropdown lists of a certain component is displayed and thereafter selection of that dropdown lists is terminated with no change of the setting contents. In this case, it may be regarded that “Selection” of that component is made and this decision may be reflected on “Selection Order” or it may be regarded that “Selection” of that component is not made and this decision may not be reflected on “Selection Order”. In a case where it is regarded that “Selection” of that component is not made as in the latter case, the order that selection which involves a change of the design of the component is made is recoded in “Selection Order” eventually.

Next, a method of extracting (deciding) one reference design to be displayed in the reference design display area 32 will be described. As the method of deciding the reference designs, there exist the following first extraction method, second extraction method and third extraction method.

(First Extraction Method)

The first extraction method includes the following steps (1-1) to step (1-3).

In step (1-1), extraction target reference designs are narrowed down from within all the reference designs and an extraction target group which consists of the extraction target reference designs is specified.

In step (1-2), a first index value which indicates a degree of similarity to the user design is derived in regards to each reference design in the extraction target group.

In step (1-3), a predetermined number (three in one embodiment) of reference designs is extracted in descending order of derived first index values.

In the following, contents of each step will be described.

In step (1-1), in all the reference designs, a group of reference designs which are the same as the user design which is obtained at that point in time in model is specified as the extraction target group. In a case where the number of the reference designs is large, it becomes possible to reduce a load which is extracted on the CPU 11 in execution of a reference design extraction process by narrowing down the number of the extraction targets in the group in advance in this way. Incidentally, in a case where the number of the reference designs is sufficiently small, in a case where there is room for the CPU 11 in processing load and so forth, execution of step (1-1) may be omitted and all the reference designs may be set as the extraction targets.

The extraction target group specification method is not limited to the above first method. For example, in all the reference designs, a group of the reference designs which are the same as the user design in the design of a certain component may be specified as the extraction target group. As an alternative, in all the reference designs, a group of reference designs that a component similarity value (which indicates the degree of similarity to the user design) of a certain component is more than a reference value may be specified as the extraction target group. The component similarity value will be described later. The certain component may be either defined in advance per model of the user design or specified on the basis of an instruction to designate any one of the plurality of components of the wristwatch 40.

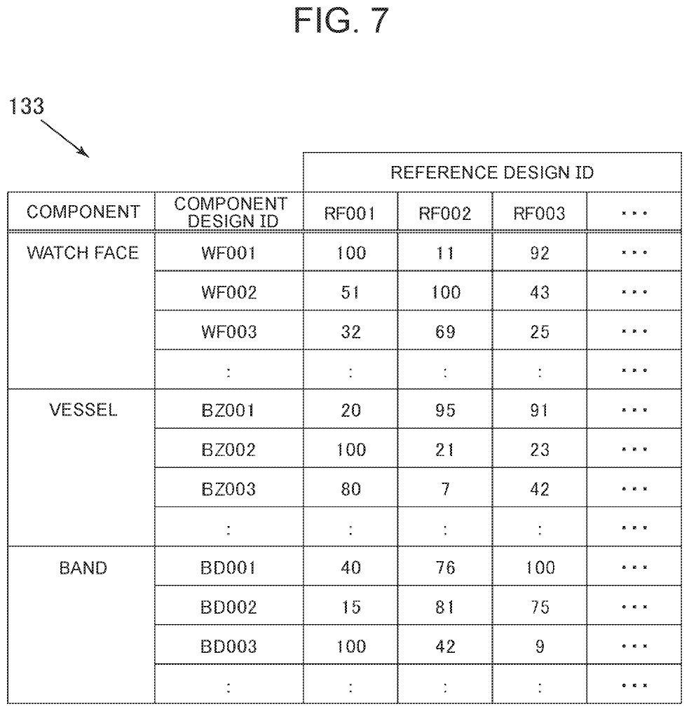

Next, in step (1-2), the first index value is derived for each reference design in the extraction target group. The component similarity value which indicates the degree of similarity between the user design and each reference design for each of the plurality of components is derived for each of the plurality of components of the wristwatch 40 and then, thereby, the first index value is derived on the basis of the plurality of component similarity values which consists of the component similarity values which are derived for each of the plurality of components. For example, the first index value is derived by adding together the plurality of component similarity values on the basis of a weighted value which is defined for each component with regards to each of the plurality of component similarity values. The component similarity value of each component is derived (specified) from the component similarity value data 133. FIG. 7 is a diagram illustrating one example of contents of the component similarity value data 133.

One data row in the component similarity value data 133 corresponds to one component design ID of one component (that is, one design of one component). The component similarity value data 133 has data rows which correspond to all the component design IDs of all the components. On the other hand, one data column in the component similarity value data 133 corresponds to one reference design. In the component similarity value data 133, each reference design is specified on the basis of reference design IDs (RF001, RF002, . . . ) each of which is peculiar to each reference design. The component similarity value data 133 has data columns which correspond to all the reference design IDs. At a point that each data row intersects with each data column, each component similarity value which indicates each degree of similarity between the design of each component which corresponds to each data row and the design of each component of each reference design which corresponds to each data column is registered. Accordingly, it becomes possible to specify the degree of similarity between an optional design of each component of the user design and the design of the corresponding component in each reference design. In FIG. 7, the component similarity values are indicated by integers which are more than 0 and less than 100. That the component similarity value is 100 indicates that the design of the component which corresponds to that data row is the same as the design of the component of the reference design which corresponds to that data column. Incidentally, a range of the component similarity values is not limited to the range from more than 0 to less than 100 and it becomes possible to set the component similarity values so as to fall within an optional range on condition that the degree of similarity between the designs is reflected within that range.

The weighting which is multiplied to the component similarity value of each component in a case of deriving the first index value is specified from the weighted data 134.

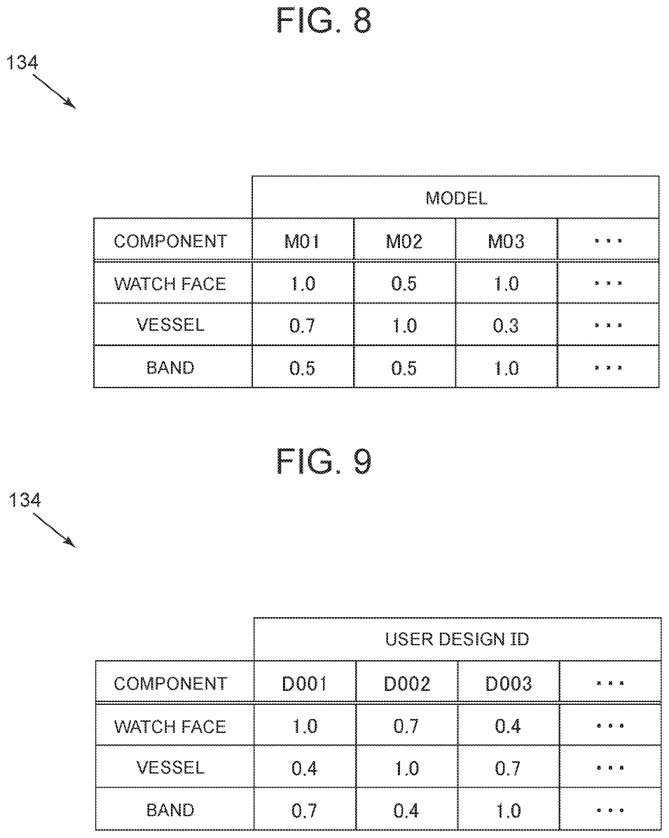

FIG. 8 is a diagram illustrating one example of the contents of the weighted data 134.

In the weighted data 134 which is indicated in FIG. 8, each weighted value which corresponds to each component of the wristwatch 40 is defined in advance and is registered for each model of the wristwatch 40. For example, in regards to the model “M01”, the weighted value to the watch face 41 is defined to “1.0”, the weighted value to the vessel 42 is defined to “0.7” and the weighted value to the band 43 is defined to “0.5”. The model-based weighting is defined to be more increased for a component which is more attractive than other components in that model and a component which is more characteristic than other components in that model. Incidentally, in the example in FIG. 8, although weighted values for the same kinds of components are different from each other between different models, these values are illustrative and the weighted values of the components of the same kind may become the same as each other between the different models as a result that the weighted value is defined in advance in accordance with the model.

An example that the first index value is derived by using the weighted values in the weighted data 134 in FIG. 8 will be shown. For example, in a case where the first index value of the reference design to which “RF 001” is assigned in FIG. 7 is derived for the user design to which is “D001” is assigned in FIG. 6, since the model of that user design is “M01”, values to be weighted to the watch face 41, the vessel 42 and the band 43 are specified as “1.0”, “0.7” and “0.5” respectively. In addition, from the data in FIG. 6, the component design IDs of the watch face 41, the vessel 42 and the band 43 of the user design “D001” are specified to “WF002”, “BZ003” and “BD001” respectively. Accordingly, the component similarity values of the respective components for the reference design “RF001” are derived as (specified to) “51”, “80” and “40” respectively by referring to the data rows “WF002”, “BZ003” and “BD001” respectively in FIG. 7. The first index value is derived as “127” (51×1.0+80×0.7+40×0.5=127) by adding together these component similarity values which are weighted with the above specified values 1.0, 0.7 and 0.5. FIG. 9 is a diagram illustrating another example of contents of the weighted data 134.

In the weighted data 134 in FIG. 9, weighted values which correspond to the respective components of the wristwatch 40 are defined in accordance with “Selection Order” of each component in the design data DD in FIG. 6. Specifically, the weighted value of the component that “Selection Order” is “1” is set to “1.0”, the weighted value of the component that “Selection Order” is “2” is set to “0.7” and the weighted value of the component that “Selection Order” is “3” is set to “0.4”. In other words, the weighted values which correspond to the respective components are defined in such a manner that in the plurality of components, the former, the order of one component which is selected for decision of the user design by the user U is, the larger, the weighted value which corresponds to that component becomes in the plurality of components in the history of the instructions which are issued from the user U for generation of the user design. The user U tends to more preferentially (that is, at an earlier stage) select and decide the design of a component that the user U regards to be more important than others in design. Accordingly, it becomes possible to more reflect the component similarity value of the component that the user U regards to be more important in design on the first index value by more increasing the weighted value to one component the design of which is selected more preferentially than others. Incidentally, the weighted value which corresponds to each component may be decided in accordance with other elements which pertain to the history of the instructions that the user U issues for generation of the user design such as, for example, the number of times that each component is selected, the number of times that the design of each component is changed and so forth. An example that the first index value is derived by using the weighted values in the weighted data 134 in FIG. 9 will be given. For example, in a case where the first index value of the reference design ID “RF001” in FIG. 7 is derived for the user design of the user design ID “D001” in FIG. 6, weighted values of the watch face 41, the vessel 42 and the band 43 are specified to “1.0”, “0.4” and “0.7” respectively from the data column of the user design ID “D001” in FIG. 9. In addition, as described above, from the data in FIG. 6 and FIG. 7, the component similarity values of the watch face 41, the vessel 42 and the band 43 in the reference design ID “RF001” are specified to “51”, “80” and “40” respectively. The first index value is derived as “111” (51×1.0+80×0.4+40×0.7=111) by adding together these component similarity values which are weighted with the above specified values 1.0, 0.4 and 0.7.

Incidentally, the weighted values in FIG. 8 and FIG. 9 are illustrative. For example, weighted values which correspond to at least some of the plurality of components may be set to values which are larger than “1”. In addition, in a case where it is desirable to reflect the component similarity values of the respective components on the first index values equally, the weighting may be omitted (in other words, the weighted values of the respective components may be made the same as one another, for example, all the weighted values may be set to, for example, “1.0”).

Next, in step (1-3), the predetermined number (three in one embodiment) of reference designs is extracted (decided).

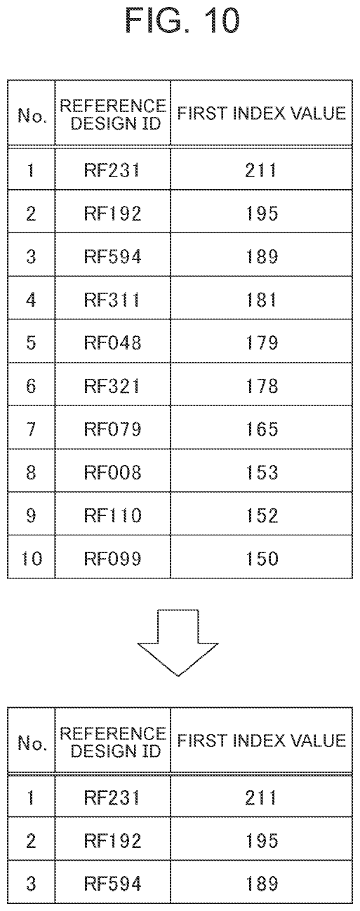

FIG. 10 is a diagram illustrating one example of a procedure of extracting the reference designs in the first extraction method.

In a case where the first index value is derived by the above-described method for each reference design (each reference design ID) in the extraction target group, the reference designs in the extraction target group are arrayed, for example, in descending order of the first index value, as shown in an upper table in FIG. 10. In FIG. 10, “No.” indicates a sequence order of the respective reference designs in a case where the reference designs are arrayed in descending order of the first index values. Then, the predetermined number (three in this example) of designs is extracted in descending order of the first index values. In the example in FIG. 10, as shown in a lower table in FIG. 10, three reference designs that “RF231”, “RF192” and “RF594” are allocated as the reference design IDs are decided as the reference designs to be displayed in the reference design display area 32.

(Second Extraction Method)

Next, the second extraction method of extracting the reference designs will be described.

The second extraction method includes the following step (2-1) to step (2-4)

In (2-1), the extraction target reference designs are narrowed down from within all the reference designs thereby to specify the extraction target group which is configured by the extraction target reference designs.

In (2-2), the first index value which indicates the degree of similarity to the user design is derived for each reference design in the extraction target group.

In (2-3), a certain number of the reference designs is extracted in descending order of the derived first index values thereby to derive (acquire) the second index value which is defined in one-to-one correspondence with each of the certain number of reference designs which are extracted.

In (2-4), the predetermined number (three in one embodiment) of the reference designs is extracted from within the certain number of reference designs in descending order of the extracted second index values.

Since step (2-1) and step (2-2) are the same as step (1-1) and step (1-2) in the first extraction method respectively, description thereof will be omitted.

The second index values which are extracted in step (2-3) are acquired from the second index value data 135.

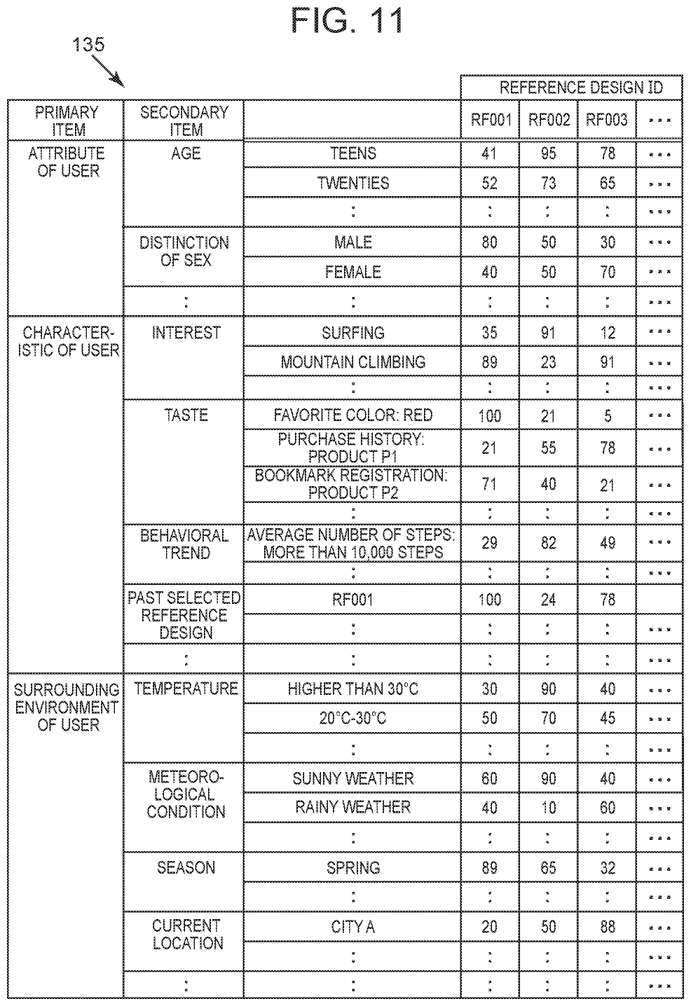

FIG. 11 is a diagram illustrating one example of contents of the second index value data 135.

In the second index value data 135, the second index values are set and registered in units of a plurality of items (tertiary items in FIG. 11) which pertains to the attribute, the characteristic and the surrounding environment of the user for each of all the reference designs (the reference design IDs). The second index values are set in such a manner that, for a reference design which is more recommended than other reference designs in a case where a certain tertiary item applies, the second index value of that reference design which corresponds to that tertiary item becomes larger than others. Here, that the tertiary item applies means that the content of that tertiary item matches the attribute, the characteristic or the surrounding environment of that user U who prepares the user design. For example, the second index value which corresponds to the tertiary item “Surfing” is set to become larger for the reference design which is more preferred by the user U who plays surfing as one interest than other reference designs.

Each tertiary item belongs to one secondary item. Each secondary item belongs to one primary item (the attribute, the characteristic or the surrounding environment of the user U). Some secondary and tertiary items which pertain to the attribute and the characteristic of the user correspond to data items in the user data 136 in FIG. 3. Incidentally, the items which pertain to all the attribute, the characteristic and the surrounding environment of the user U may not necessarily be contained in the second index data 135.

The secondary items which belong to the primary item “Attribute of User” are, for example, “Age”, “Distinction of Sex”, “Residence Area” and so forth. In these secondary items, tertiary items such as “Teens”, “Twenties” and so forth belong to the secondary item “Age” and tertiary items such as “Male”, “Female” and so forth belong to the secondary item “Distinction of Sex”.

Secondary items which belong to the primary item “User's Characteristic” are, for example, “Interest”, “Taste”, “Behavioral Trend”, “Past Selected Reference Designs” and so forth. In these secondary items, tertiary items such as “Surfing”, “Mountain Climbing” and so forth belong to the secondary item “Interest”. In addition, tertiary items such as “Favorite Color”, “Purchase History”, “Bookmark Registration” and so forth belong to the secondary item “Taste”. In addition, tertiary items such as “Average Steps” and so forth belong to the secondary item “Behavioral Trend”. A tertiary item which indicates the reference design IDs of the reference designs belongs to the secondary item “Past Selected Reference Designs”. The second index value which corresponds to each tertiary item (the reference design ID) of “Past Selected Reference Designs” is set so as to become higher for a reference design which is higher in degree of similarity to the reference design in the tertiary item (that is, so as to be more strongly recommended).

The secondary items which belong to the primary item “User's Surrounding Environment” are “Temperature”, “Meteorological Condition”, “Season”, “Current Position” and so forth. In these secondary items, tertiary items such as “Higher than 30° C.”, “20° C.-30° C.” and so forth belong to the secondary item “Temperature”. In addition, tertiary items which indicate the weather such as “Sunny Weather”, “Rainy Weather” and so forth and tertiary items which indicate parameters which relate to the weather such as “Wind Velocity”, “Atmospheric Pressure”, “Humidity” and so forth belong to the secondary item “Meteorological Condition”. In addition, tertiary items which pertain to city names and tertiary items such as metropolis and districts, region, nation, latitude range and so forth belong to the secondary item “Current Location”. The above secondary items and tertiary items are illustrative and items are not limited to these secondary and tertiary items. For example, the secondary item “Behavioral Trend” may contain tertiary items which pertains to the wristwatch 40 that the user U wears and usage conditions (frequency of use) of functions of the wristwatch 40. Specifically, in a case where the wristwatch 40 has a function of acquiring wear frequency (whether the user U uses the wristwatch 40 every day and so forth) of the wristwatch 40, azimuth directions, the number of steps, regions, calories and so forth, the secondary item “Behavioral Trend” may contain tertiary items which pertain to results of acquisition of the numerical values and so forth of the above items. In addition, the secondary item “Behavioral Trend” may also contain tertiary items which pertain to the model of the terminal device 20 (for example, the smartphone) that the user U uses and usage conditions (frequency of use) of functions of the terminal device 20. In addition, the tertiary items “Purchase History” and “Bookmark Registration” may contain contents of the purchase history and the bookmark registration in a service other than the e-commerce service that the information processing system 1 provides.

In addition, in a case where there is no tertiary item which belongs to a secondary item, the second index values may be set in one-to-one correspondence with the secondary item.

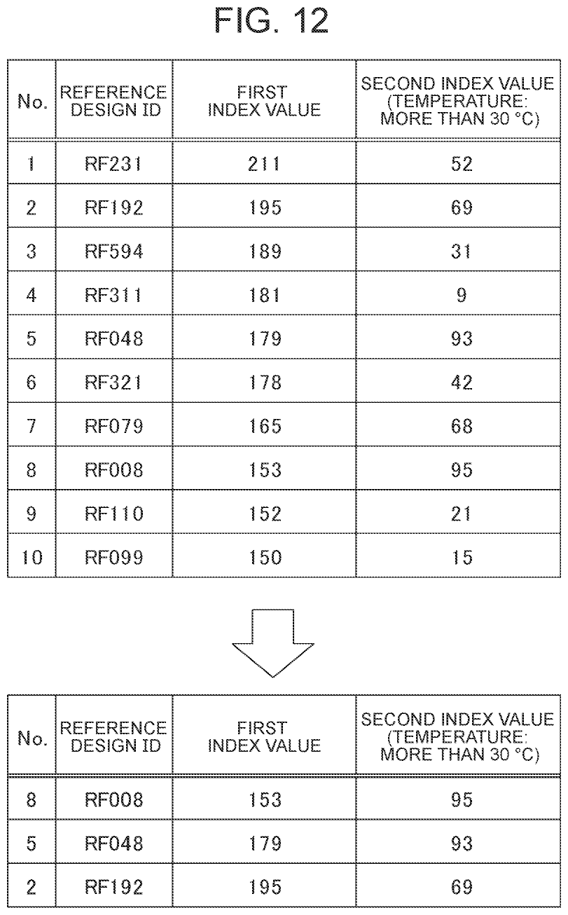

In the following, step (2-3) and step (2-4) will be described with reference to FIG. 12.

FIG. 12 is a diagram illustrating one example of a procedure of extracting the reference designs in the second extraction method.

In step (2-3), as indicated in an upper table in FIG. 12, reference designs in the extraction target group are arrayed such that, for example, the first index values are indicated in descending order. Then, a certain number (ten in FIG. 12) of reference designs are extracted in descending order of the first index values and the second index values which are defined in one-to-one correspondence with the certain number of the extracted reference designs are derived (acquired).

In the next step (2-4), the predetermined number (three in one embodiment) of reference designs is extracted from the certain number of the reference designs in the descending order of the derived second index values.

The first-stage extraction which is based on the first index values is performed in step (2-3) in this way and the second stage extraction which is based on the second index values is performed in the next step (2-4).

Describing in more details, in step (2-3), first, the user data 136 is referred to and any one of the tertiary items which applies to the attribute or the characteristic of the user U who prepares the user design is selected in the tertiary items in FIG. 11. Otherwise, any one of the tertiary items which applies to the surrounding environment of the user U which is acquired by the environment information acquisition unit 27 of the terminal device 20 is selected in the tertiary items in FIG. 11. The tertiary items may be also set in such a manner that user U is able to select one tertiary item from within the plurality of the tertiary items which apply to the above situations. Then, the second index value which corresponds to the selected tertiary item is acquired for each of the certain number of the above reference designs. In FIG. 12, the tertiary item “Temperature: Higher Than 30° C.” is selected and the second index value which corresponds to the tertiary item “Temperature: Higher than 30° C.” is acquired for each of the reference designs No. 1 to No. 10.

Then, in step (2-4), as indicated in the lower table in FIG. 12, the predetermined number (three in the example in FIG. 12) of reference designs is extracted (decided) as the reference designs to be displayed in the reference design display area 32 in descending order of the acquired second index values in the extracted ten reference designs. In the example in FIG. 12, in the reference designs that No. 1 to No. 10 are assigned, the reference design to which “RF008” which is the largest in the second index value is assigned, the reference design to which “RF048” which is the second largest in the second index value is assigned and the reference design to which RF192” which is the third largest in the second index value is assigned are extracted. According to the second extraction method such as the above, it becomes possible to extract reference designs which are recommended in accordance with the attribute, the characteristic, or the surrounding environment of the user U from within the reference designs which are similar to the user design and to present the extracted reference designs to the user U.

(Third Extraction Method)

Next, the third extraction method of extracting the reference designs will be described.

The third extraction method includes the following step (3-1) to step (3-5).

In (3-1), the extraction target reference designs are narrowed down from within all the reference designs thereby to specify the extraction target group which is configured by the narrowed-down extraction target reference designs.

In (3-2), in regard to each of the reference designs in the extraction target group, the first index value which indicates the degree of similarity to the user design is derived.

In (3-3), in regard to each of the reference designs in the extraction target group, the second index value which is defined in one-to-one correspondence with each reference design is derived (acquired).

In (3-4), the first index value of each reference design is corrected on the basis of the second index value.

In (3-5), the predetermined number (three in one embodiment) of reference designs is extracted in descending order of the corrected first index values.

Since step (3-1) and step (3-2) are the same as step (2-1) and step (2-2) in the second extraction method respectively, description thereof will be omitted.

A way of deriving (acquiring) the second index value in step (3-3) is partially the same as that of step (2-3) of the second extraction method. That is, first, the user data 136 is referred to and, in the tertiary items in FIG. 11, any one of the tertiary items which applies to the attribute or the characteristic of the user U who prepares the user design is selected. As an alternative, in the tertiary items in FIG. 11, any one of the tertiary items which applies to the surrounding environment of the user U which is acquired by the environment information acquisition unit 27 of the terminal device 20 is selected. It may become also possible for the user U to select one tertiary item from within the plurality of the tertiary items which applies to the user's surrounding environment. Then, the second index value which corresponds to the selected tertiary item is acquired for each of the reference designs in the extraction target group.

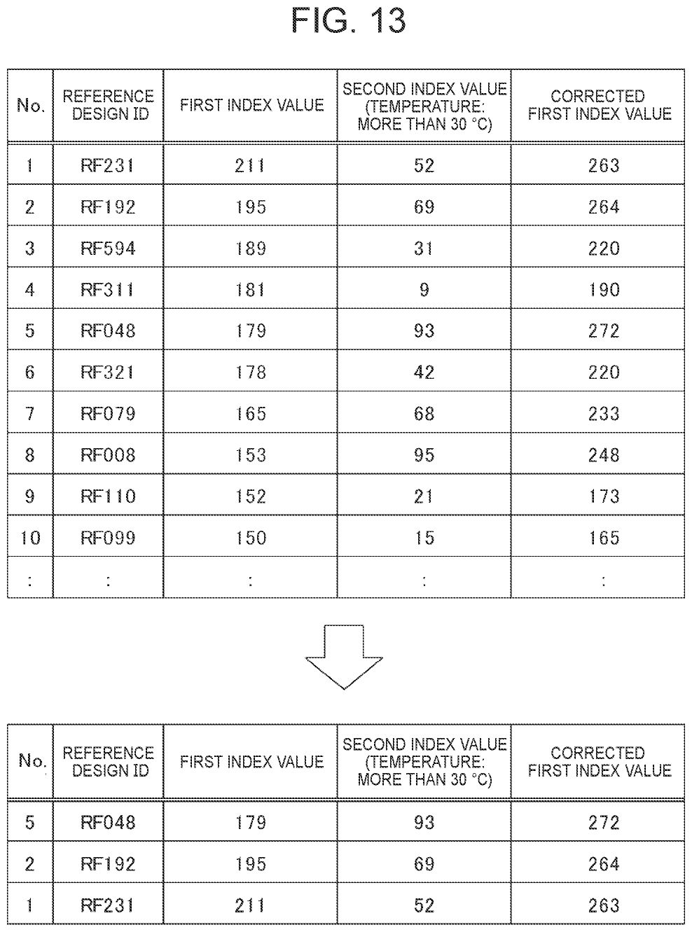

In the following, step (3-4) and step (3-5) will be described with reference to FIG. 13.

FIG. 13 is a diagram explaining one example of a reference design extraction procedure in the third extraction method.

In step (3-3), the second index value of each reference design in the extraction target group is acquired and then in step (3-4), the first index value of each reference design is corrected on the basis of the acquired second index value. In the example which is indicated in an upper table in FIG. 13, the second index value of each reference design is added to the first index value of each reference design and thereby the first index value which is corrected is derived. A way of correction may be a way by which the larger the second index value is, the larger an increase amount or an increase rate becomes and is not limited to simple addition of values. For example, the second index value may be converted to a value which correlates with the magnitude of that second index value and then the second index value which is so converted may be added to the first index value. As an alternative, the second index value or a value which correlates with the second index value may be multiplied by the first index value.

Then, in step (3-5), as indicated in a lower table in FIG. 13, the predetermined number (three in the example in FIG. 13) of reference designs is extracted (decided) as the reference designs to be displayed in the reference design display area 32. In the example in FIG. 13, respective reference designs of “RF048” that the first index value which is obtained after correction is the largest, “RF 192” which is the second largest and “RF231” which is the third largest are extracted.

According to the third extraction method such as the above, it becomes possible to extract the reference designs which are recommended in accordance with the attribute, the characteristic or the surrounding environment of the user U from within the reference designs which are similar to the user design and then to present the extracted reference designs to the user U. In addition, since the first index value of each reference design which is included in the extraction target group is corrected, in a case where there exists a reference design which is strongly recommended in accordance with the attribute, the characteristic or the surrounding environment of the user U although the first index value of that reference design is small, it becomes possible to extract and present that reference design to the user U.

Incidentally, the plurality of second index values which corresponds to the plurality of tertiary items in FIG. 11 may be acquired and then the first index value of each reference design may be corrected on the basis of the plurality of acquired second index values. Thereby, it becomes possible to extract reference designs which are particularly recommended in a case of applying to any of the plurality of tertiary items (for example, “Age”, “Interest” and so forth) in the user's attribute, characteristic and surrounding environment. Accordingly, it becomes possible to extract reference designs which would readily assist in conceiving of designs which are more appropriate for the user U.

Incidentally, the first extraction method may be combined with the second extraction method or the third extraction method. That is, in addition to the reference designs which are extracted by using the second extraction method and the third extraction method, the predetermined number of reference designs may be further extracted in descending order of the first index values.

In addition, reference designs which are too similar to the user design may be excluded from the extraction targets. This is because there are cases where it is difficult to use the reference designs which are quite similar to the user design as assistance in conceiving of the designs on the contrary. For example, when using the weighted values in the weighted data 134 in FIG. 8, in a case where the user design and the reference design are entirely the same as each other (in a case where all the component similarity values are 100), the first index value reaches a maximum value “220”. Accordingly, a reference design that, for example, the first index value occupies more than a predetermined rate (for example, more than 95% and so forth) relative to the maximum value may be decided to exclude from the extraction objects. As an alternative, an upper limit of the first index value on the basis of which each reference design is decided as the extraction object may be defined.

<Control Procedure of Design Processing>

Next, design processing that the CPU 11 of the server 10 executes for realizing the operation of the above-described information processing system 1 will be described.

FIG. 14 is a flowchart illustrating one example of a control procedure of the design processing.

Execution of the design processing is started in a case where a request for displaying designs on the design screen 30 is transmitted from the terminal device 20 to the server 10 and the server 10 receives the request for displaying the designs in order to customize the design of the article to be purchased (the wristwatch 40) and the server 10 receives the request for displaying the designs.

In a case where execution of the design processing is started, the CPU 11 makes the display unit 25 of the terminal device 20 display the design screen 30 and accepts an inputting operation for design changing by the user U (step S101).

The CPU 11 decides whether the timing for displaying the reference designs in the reference design display area 32 comes (step S102). Here, the CPU 11 decides that the timing for displaying the reference designs in the reference design display area 32 comes, for example, in a case where the reference designs are displayed (updated) previously and after that the design of any one of the components is changed. The timing for displaying the reference designs is not limited to the above timing and the timing for displaying the reference designs may be also set, for example, in a case where a reference design display instruction is issued from the user U and so forth.

In a case where it is decided that the timing for displaying the reference designs comes (“YES” in step S102), the CPU 11 executes a reference design extraction process (an extraction process) which will be described later (step S103) and extracts the display designs to be displayed. In addition, the CPU 11 makes the display unit 15 display the extracted reference designs in the reference design display area 32 of the design screen 30 (step S104).

The CPU 11 decides whether an instruction to introduce one reference design into the user design is issued (step S105). In the example in FIG. 14, in a case where an operation of selecting one reflection button 321 in the reference design display area 32 is performed, the CPU 11 decides that the instruction to introduce one reference design into the user design is issued.

In a case where it is decided that the instruction to introduce one reference design into the user design is issued (“YES” in step S106), the CPU 11 replaces the user design with the instructed reference design and updates the contents in the user design display area 31 and the component design areas 33, 34 and 35 to the contents of the instructed reference design (step S106).

In a case where execution of the process in step S106 is terminated or in a case where it is decided that an instruction to introduce the reference design into the user design is not issued in step S105 (“NO” in step S105), the CPU 11 decides whether the user design is determined as the design of the wristwatch 40 to be purchased (step S107). For example, in a case where an operation of selecting the purchase determination button (not illustrated) on the design screen 30 is performed, the CPU 11 decides that the user design which is displayed at that point in time is determined as the design of the wristwatch 40 to be purchased. In a case where the CPU 11 decides that the user design is not determined as the design of the wristwatch 40 to be purchased (“NO” in step S107), the CPU 11 returns the process to step S102. Then, in a case where it is decided that the user design is determined as the design of the wristwatch 40 to be purchased (“YES” in step S107), the CPU 11 terminates execution of the design processing.

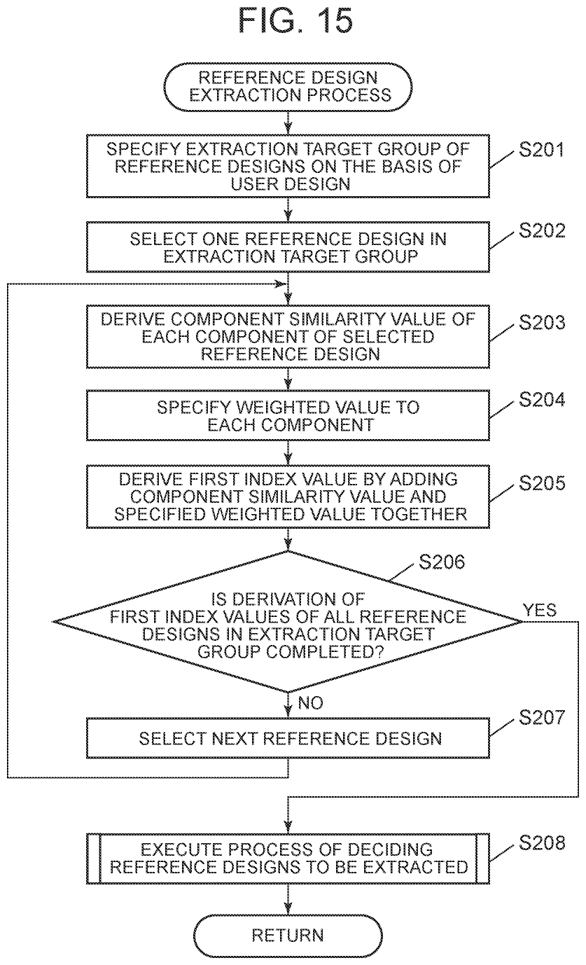

FIG. 15 is a flowchart illustrating one example of a control procedure of the reference design extraction process in FIG. 14.

In a case where the reference design extraction process is called, the CPU 11 specifies one extraction target group of the reference designs on the basis of the user design which is obtained at that point in time (step S201). For example, the CPU 11 extracts some reference designs which are the same as the user design which is obtained at that point in time in model in all the reference designs and sets the extracted reference designs as the extraction target group. As an alternative, the CPU 11 extracts reference designs which are the same as the user design in the design of a certain component or reference designs that the component similarity value of a certain component is more than the reference value and sets the reference designs which are extracted in this way as the extraction target group.

The CPU 11 selects one reference design which belongs to the extraction target group (step S202) and derives (specifies) the component similarity value of each component of the selected reference design (step S203). That is, the CPU 11 specifies the component design ID of each component of the user design with reference to the user design data 132 in FIG. 6 and specifies the component similarity value which corresponds to each component in each selected reference design with reference to the component similarity value data 133 in FIG. 7.

The CPU 11 specifies a weighting to each component (step S204). For example, in a case where such a setting that the weighting is specified per model of the user design is made, the CPU 11 specifies the model of the user design with reference to the user design data 132 in FIG. 6 and specifies the weighting to each component which is set in one-to-one correspondence with the model concerned in the weighted data 134 in FIG. 8. In addition, in a case where such a setting that the weighting is specified in accordance with the selection order that the respective components are selected by the user U is made, the CPU 11 specifies the weighting to each component which is set in one-to-one correspondence with the user design which is obtained at the point in time in the weighted data 134 in FIG. 9 which is generated on the basis of the selection order.

The CPU 11 derives the first index value by mutually adding the component similarity values of the respective components with addition of the weighted values which are specified in step S204 (step S205).

The CPU 11 decides whether derivation of the first index values is completed for all the reference designs which are contained in the extraction target group (step S206). In a case where it is decided that the first index value of any one of the reference designs in the extraction target group is not derived (“NO” in step S206), the CPU 11 selects the next reference design which belongs to the extraction target group (step S207) and returns the process to step S203.

In a case where it is decided that derivation of the first index values of all the reference designs in the extraction target group is completed (“YES” in step S206), the CPU 11 executes an extracted reference design determination process which will be described later (step S208) and extracts the predetermined number of the reference designs which is to be displayed in the reference design display area 32. At completion of execution of the process in step S208, the CPU 11 returns the process to the design processing.

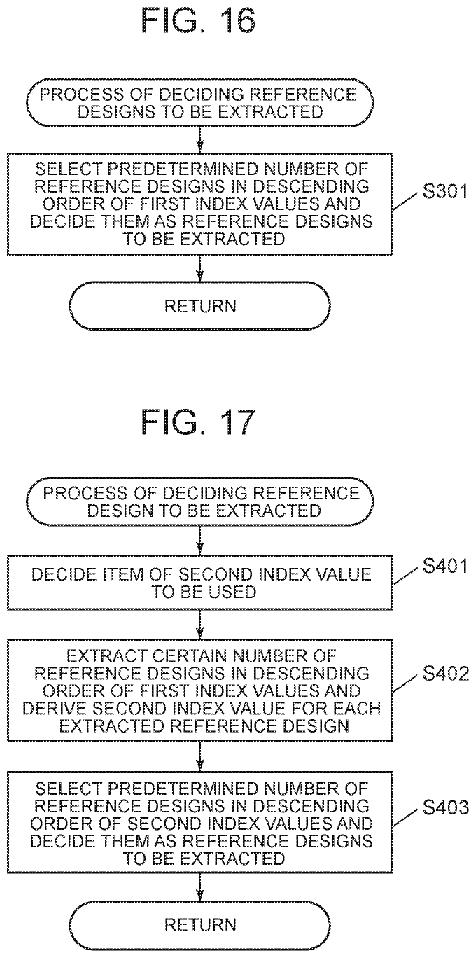

FIG. 16 is a flowchart illustrating one example of a control procedure of a process of determining reference designs to be extracted which is executed in a case of using the first extraction method.

In a case where the process of determining the reference designs to be extracted is called, the CPU 11 selects the predetermined number (three in one embodiment) of the reference designs in descending order of the first index values in the reference designs in the extraction target group and determines the selected reference designs as the reference designs to be extracted (step S301). At termination of execution of the process in step S301, the CPU 11 returns the process to the reference design extraction process.

FIG. 17 is a flowchart illustrating one example of a control procedure of a process of determining reference designs to be extracted which is executed in a case of using the second extraction method.

In a case where the process of determining the reference designs to be extracted is called, the CPU 11 determines the item of the second index values to be used (the tertiary item in the second index value data 135 in FIG. 11) (step S401). Describing in detail, the CPU 11 selects any one of the items which applies to the attribute or the characteristic of the user U who prepares the user design with reference to the user data 136. As an alternative, the CPU 11 selects any one of the items which applies to the surrounding environment of the user U which is acquired by the environment information acquisition unit 27 of the terminal device 20.

The CPU 11 extracts a certain number (for example, ten in the example in FIG. 12) of the reference designs in the reference designs in the extraction target group in descending order of the first index values in the reference designs in the extraction target group. In addition, the CPU 11 derives (acquires) the second index values of the item which is determined in step S401 with reference to the second index data 135 in FIG. 11 for each of the certain number of reference designs which are extracted (step S402).

The CPU 11 selects the predetermined number (three in one embodiment) of reference designs in descending order of the acquired second index values and determines the selected reference designs as reference designs to be extracted (step S403). At termination of execution of the process in step S403, the CPU 11 returns the process to the reference design extraction process.

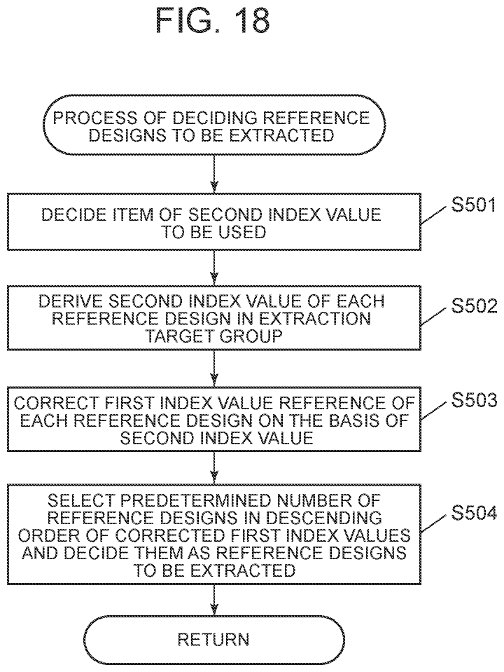

FIG. 18 is a flowchart illustrating one example of a control procedure of a process of determining reference designs to be extracted which is executed in a case of using the third extraction method.

In a case where the process of determining the reference designs to be extracted is called, the CPU 11 determines the item of the second index values to be used (step S501). The process in step S501 is the same as the process in step S401 in FIG. 17.

The CPU 11 derives (acquires) the second index value in the item which is determined in step S501 in regard to each reference design in the extraction target group with reference to the second index value data 135 in FIG. 11 (step S502).

The CPU 11 corrects the first index value on the basis of the second index value in regard to each reference design (step S503). For example, the CPU 11 adds the second index value to the first index value and thereby sets the added value as a corrected first index value of each reference design.

The CPU 11 selects the predetermine number (three in one embodiment) of the reference designs in descending order of the corrected first index values and decides the selected three reference designs as the reference designs to be extracted (step S504). At termination of execution of the process in step S504, the CPIU 11 returns the process to the reference design extraction process.

<Effects>

According to Japanese Patent No. 6034448 or No. 6709308, there is proposed the technology of making the design that other users who have the attributes and the preferences in common with the user creates display as the reference designs for assist in conceiving the design by the user. However, even among the users who have the attributes and the preferences in common with one another, the users do not necessarily have even design trends in common with one another. Therefore, the above prior arts have such an issue that there are many cases where reference designs which would hardly assist in conceiving the design for the user who makes designs are displayed.

As described above, the server 10 which functions as the information processing apparatus according to one embodiment includes the CPU 111 which functions as the processing unit. The CPU 11 acquires the design data DD which pertains to the user design of the wristwatch 40 as the article which is generated on the basis of the instruction from the user U and which has the plurality of components, executes the extraction process of extracting at least one reference design from within the plurality of preliminarily generated reference designs of the article on the basis of the design index DD and makes the display unit 25 display the information which pertains to at least one reference design which is extracted by execution of the extraction process. In the extraction process, the CPU 11 derives the component similarity value which indicates the degree of similarity between each of some reference designs or all the reference designs in the plurality of reference designs and the user design for each of the plurality of components, in regards to each of the plurality of components, then, derives the first index values on the basis of the plurality of component similarity values which consists of the component similarity values which are derived for each of the plurality of components and extracts at least one reference design on the basis of the derived first index value from the plurality of reference designs. Thereby, it becomes possible to extract and display the reference designs which are high in the degree of similarity of the design of each component to the user design in the plurality of reference designs. Accordingly, it becomes possible to display more appropriate reference designs which would readily assist in conceiving of the designs for the user U who customizes the designs of the components of the wristwatch 40. In addition, it becomes possible for the user U to customize the user design to the user's favorite design by a simple method of replacing the user design with any one of the displayed reference designs and/or adopting part of any one of the displayed reference designs into the user design.

In addition, the first index value is derived by mutually adding the plurality of component similarity values on the basis of the weighted value which is defined for each component in regard to the plurality of component similarity values. Thereby, it becomes possible to more greatly reflect the component similarity values of important components such as a component which would readily attract notice, a component that the user U emphasizes in design and so forth on the first index values. Accordingly, since it becomes easy to extract the reference designs which are similar to the user design in important components even in a case where components other than the important components are not similar to the corresponding components of the user design, it becomes possible to extract and display the reference designs that the user U would readily feel to be more appropriate when viewing the entire of the article.

In addition, the user design and the plurality of reference designs are designs which pertain to any one of the plurality of models of the wristwatch 40 and the above-described weighted value is a value which is defined in advance in accordance with the model which corresponds to the user design. Thereby, it becomes possible to more greatly reflect the component similarity values of important components such as, for example, components which are readily eye-catching, components which are characteristic and so forth in the basic design of the model on the first index values by appropriately defining the weighted values per model.

In addition, the above weighted values are the values which are defined in accordance with the history of the instructions that the user U made for generation of the design data DD. Thereby, it becomes possible to more greatly reflect the component similarity values of the important components that the user U put emphasis in design on the first index values. Accordingly, it becomes possible to display more appropriate reference designs which would readily assist in conceiving of the design for the user.

In addition, the design data DD is generated on the basis of the instruction which is issued from the user U for component-based determination of designs of at least some of the plurality of components and the weighted value is defined in such a manner that, in the plurality of components, the earlier the order of the component which is selected by the user U for decision of the design is, the more the weighted value which corresponds to that component is increased. The user U tends to decide the design of the component that the user U places importance in design more preferentially (that is, at an early stage). Therefore, it becomes possible to more greatly reflect the component similarity value of the component that the user U places importance in design on the first index value by more increasing the weighted value to be applied to the component which is selected earlier than other components.

In addition, in the first extraction method which is used for extraction of the reference designs, in the extraction process, the CPU 11 extracts at least one reference design in descending order of the derived first index values from the plurality of reference designs. Thereby, it becomes possible to readily extract and display the reference designs which are high in degree of similarity to the user design.

In addition, in the second extraction method which is used for extraction of the reference designs, in the extraction process, the CPU 11 extracts the certain number of reference designs in descending order of the derived first index values, derives the second index values which are defined in one-to-one correspondence with the certain number of the extracted reference designs respectively and extracts at least one reference design in descending order of the derived second index values from the plurality of reference designs. Thereby, it becomes possible to extract the reference designs which are similar to the user design on the basis of the first index values and then to more narrow down the reference designs which are appropriate for the user U on the basis of the second index values and from a viewpoint which is different from the degree of similarity to the user design.

In addition, in the third extraction method which is used for extraction of the reference designs, in the extraction process, the CPU 11 derives the second index values which are defined in one-to-one correspondence with the reference designs for each of some of or all the reference designs, corrects the first index value of each of some of or all the reference designs on the basis of the derived second index value and extracts at least one reference design from the plurality of reference designs on the basis of the corrected first index value. Thereby, it becomes possible to further narrow down the reference designs which are appropriate for the user U from within the reference designs which are similar to the user design from the viewpoint which is different from the degree of similarity to the user design.

In addition, the second index values are defined in units of the plurality of items which pertains to at least one of the attribute, the characteristic and the surrounding environment of the user U and are set such that for a reference design which is more recommended than other reference designs in a case where a certain item applies in the plurality of items, the second index value which corresponds to that certain item is more increased. The CPU 11 acquires the second index values which correspond to the items which apply to the attribute, the characteristic or the surrounding environment of the user U at the time of execution of the extraction process, in the plurality of items. Thereby, it becomes possible to extract reference designs which are recommended in accordance with the attribute, the characteristic or the surrounding environment of the user U from within the reference designs which are similar to the user design and then to display the extracted reference designs.

In addition, the attribute contains at least one of the age, the distinction of sex and the residence area. Thereby, it becomes possible to extract reference designs which are recommended from the viewpoint of the attribute of the user U and then to display the extracted reference designs. For example, it becomes possible to extract reference designs which are popular with other users who are the same as the user U in the age, the distinction of sex or the residence area and then to display the extracted reference designs.

In addition, the characteristic contains at least one of the interest, the taste, the behavioral trend and the past selected reference designs. Thereby, it becomes possible to extract reference designs which are recommended from the viewpoint of the characteristic of the user U and then to display the extracted reference designs. For example, it becomes possible to extract reference designs which are popular with other users who are common with the user U in the interest, the taste or the behavioral trend, reference designs which are similar to the reference designs that the user U selected in the past and so forth and then to display the extracted reference designs. More specifically, it becomes also possible to extract reference designs which are popular with other users who use a certain function of the wristwatch 40 at a frequency which is similar to the frequency of the user U.

In addition, the surrounding environment contains at least one of the temperature, the meteorological condition, the season and the current position. Thereby, it becomes possible to extract reference designs which are recommended from the viewpoint of the surrounding environment of the user U and then to display the extracted reference designs. For example, it becomes possible to extract reference designs which are similar to the design of a wristwatch which is well bought under a temperature condition and a meteorological condition which are the same as the temperature and the meteorological condition in the surrounding environment of the user U, reference designs which are similar to the design of a wristwatch which is well bought at the current position of the user U and so forth and then to display the extracted reference designs.

In addition, the user design and the plurality of reference designs are designs which pertain to any one of the plurality of models of the article. In the extraction process, the CPU 11 specifies reference designs which are the same as the user design in the model in the plurality of reference designs and derives the first index values for the specified reference designs. In a case where the number of the reference designs is large, it becomes possible to reduce a load which is exerted on the CPU 11 in execution of the extraction process of the reference designs by narrowing down in advance the extraction target group in this way. In addition, it becomes possible to narrow down the reference designs which are similar to the user design to some extent with ease by setting reference designs which are the same as each other or one another in model as the extraction target group.

In addition, in the extraction process, the CPU 11 specifies a reference design which is the same as the user design in design of a component which is included in the plurality of components or that its value of component similarity to the user design is more than a reference value and derives the component similarity value which indicates the degree of similarity between the extracted reference design and the user design per component of the plurality of components for each of the plurality of components. Thereby, it becomes also possible to narrow down the reference designs which are similar to the user design to some extent with ease.

In addition, the article to be designed may be the wristwatch. Thereby, it becomes possible to extract the reference designs of the wristwatch which are appropriate for the user U and then to display the extracted reference designs.

In addition, an information processing method pertaining to one embodiment is executed by the CPU 11 which functions as the computer of the server 10 which functions as the information processing apparatus. The CPU 11 acquires the design data DD which pertains to the user design which is generated for an article which has the plurality of components on the basis of the instruction from the user U and executes the extraction process of extracting at least one reference design from the plurality of reference designs of the wristwatch which are generated in advance on the basis of the design data DD and makes the display unit 25 display information which pertains to at least one reference design which is extracted by the extraction process. In the extraction process, the component similarity value which indicates the degree of similarity between each of some of or all the reference designs in the plurality of reference designs and the user design for each of the plurality of components is derived for each of the plurality of components, the first index value is derived on the basis of the plurality of component similarity values which consists of the component similarity values each of which is derived for each of the plurality of components and at least one reference design is extracted from the plurality of reference designs on the basis of the derived first index value. Thereby, it becomes possible to extract the reference designs which are high in degree of similarity to the user design in the plurality of reference designs. Accordingly, it becomes possible to display more appropriate reference designs which would readily assist in conceiving of the design of each component for the user U who customizes the design.

In addition, the program 131 which is stored in the non-transitory computer-readable recording medium which pertains to one embodiment makes the CPU 11 which functions as the computer of the server 10 which functions as the information processing apparatus realize a function of acquiring the design data DD which is generated on the basis of the instruction from the user U and which pertains to the user design of the article which has the plurality of components, a function of executing the extraction process of extracting at least one reference design from the plurality of reference designs of the wristwatch which is generated in advance on the basis of the design data DD and a function of making the display unit 25 display the information which pertains to at least one reference design which is extracted by execution of the extraction process. In the extraction process, the component similarity value which indicates the degree of similarity between each of some of or all the reference designs in the plurality of reference designs and the user design for each of the plurality of components is derived for each of the plurality of components, the first index value is derived on the basis of the plurality of component similarity values which consists of the component similarity values each of which is derived for each of the plurality of components and at least one reference design is extracted from the plurality of reference designs on the basis of the derived first index value. Thereby, it becomes possible to extract the reference designs which are high in degree of similarity to the user design in the plurality of reference designs. Accordingly, it becomes possible to display more appropriate reference designs which would readily assist in conceiving of the design of each component for the user U who customizes the design.

### Others

Incidentally, the description which is made in relation to one embodiment merely exemplifies the information processing apparatus, the information processing method and the non-transitory computer-readable recording medium which stores the program according to the present invention and the present invention is not limited to one embodiment.

For example, although in one embodiment, the description is made by using the example that the images of the wristwatch 50 are displayed in the reference design display area 32 as the extracted reference designs, in place of or in addition to display of the images of the wristwatch 50, other information which pertains to the extracted reference designs such as, for example, the reference design IDs, the component design IDs, the outer appearance of each component, the creator's name and so forth may be displayed.

In addition, although the description is made by giving a case where the information processing system 1 provides the e-commerce service as one example, the information processing system 1 is not limited to the above-described type and may be of the type of generating design data on an article other than the transaction target in the e-commerce transaction. For example, the information processing system 1 may be of the type of being simply used by the user U for designing the article.

In addition, in one embodiment, the terminal device 20 may execute the processing that the server 10 which functions as the information processing apparatus executes. In this case, the terminal device 20 corresponds to the information processing apparatus and the CPU 21 of the terminal device 20 corresponds to the processing unit.

In addition, although the wristwatch is exemplified as the article to be designed in one embodiment, the article to be designed is not limited to the wristwatch. The article to be designed may be electronic equipment such as, for example, an electronic musical instrument, an electronic toy, an electrical appliance and so forth and may be articles other than the electronic equipment such as, for example, clothes, shoes, ornaments and other optional articles.

In addition, the design data DD may not contain component data which pertains to all the plurality of components that one article has. For example, in a case where only data which pertains to some components in a plurality of components is contained in the design data DD, in regard to the design of a component other than some components which are described above, it may be regarded that a design which is determined in advance (is in a default state) is designated.

In addition, the component similarity value, the first index value and the second index value may not necessarily be numerical values and may be codes, marks (for example, A, B, C, . . . ) and so forth which are determined in advance as ones which indicate the magnitude of a degree and so forth.

In addition, although the description is made by using an example of deriving the component similarity value with reference to the component similarity value data 133 in one embodiment, the way of deriving the component similarity value is not limited to the above. The component similarity value may be derived by well-known image analysis processing on the basis of, for example, an image of the component which is displayed as the user design and images of the components which are displayed as the reference designs. This image analysis processing may include a process which is used to search for similar images such as, for example, a process of deciding the similarity degree by comparing characteristic amounts which are derived from images of components with each other.

In addition, although in the above description, the example that the storage units 13 and 23 are used as computer-readable media which store the program pertaining to the present invention is disclosed, the present invention is not limited to the above-described example. It is also possible to apply information recording media such as an HDD (Hard Disc Drive), an SSD (Solid State Drive), a flash memory, a CD-ROM (Compact Disc Read Only Memory) and so forth as other computer-readable media. In addition, also carrier waves are applied to the present invention as a medium which provides data on the program which pertains to the present invention via a communication line.

In addition, it goes without saying that it is possible to appropriately change detailed configurations and detailed operations of configurational elements of the server 10 and the terminal device 20 in one embodiment within a range not deviating from the gist of the present invention.

What is claimed is:

1. An information processing apparatus comprising:
a processing unit, wherein
the processing unit
acquires design data which pertains to a target design of an article which has a plurality of components,
executes an extraction process of extracting at least one reference design from a plurality of reference designs of the article on the basis of the design data,
makes a display unit display information pertaining to at least the one reference design which is extracted by the extraction process, and
in the extraction process,
derives a component similarity value which indicates a degree of similarity between each of some or all reference designs in the plurality of reference designs and the target design in regards to each of the plurality of components,
derives a first index value on the basis of a plurality of component similarity values which consist of the component similarity values which are derived in regards to each of the plurality of components, and
extracts the at least one reference design from the plurality of reference designs on the basis of the derived first index value.

2. The information processing apparatus according to claim 1, wherein
the target design is generated on the basis of an instruction from a user.

3. The information processing apparatus according to claim 1, wherein
the first index value is derived by adding the plurality of component similarity values together on the basis of a weighted value which is defined per component for each of the plurality of component similarity values.

4. The information processing apparatus according to claim 3, wherein
the target design and the plurality of reference designs pertain to any one of a plurality of models of the article and
the weighted value is defined in advance in accordance with the model which corresponds to the target design.

5. The information processing apparatus according to claim 3, wherein
the weighted value is defined in advance in accordance with a history of user's instructions which are issued for generation of the design data.

6. The information processing apparatus according to claim 5, wherein
the design data is generated on the basis of the user's instruction which is issued for deciding designs of at least some components in the plurality of components per component, and
the weighted value is defined in such a manner that, in the history, the earlier the order of one component which is selected for design decision by the user is set in the plurality of components, the more the weighted value which corresponds to that component is increased.

7. The information processing apparatus according to claim 1, wherein
the processing unit extracts at least the one reference design in descending order of the derived first index values from the plurality of reference designs in the extraction process.

8. The information processing apparatus according to claim 2, wherein
the processing unit, in the extraction process,
extracts a certain number of the reference designs in descending order of the derived first index values and derives a second index values which is defined in one-to-one correspondence with each of the certain number of the extracted reference designs, and
extracts the at least one reference design in descending order of the derived second index values from the certain number of the reference designs.

9. The information processing apparatus according to claim 2, wherein
the processing unit, in the extraction processing,
derives a second index value which is defined in one-to-one correspondence with each of the reference designs in regard to each of some of or all the reference designs,
corrects the first index value of each of some of or all the reference designs on the basis of the derived second index value, and
extracts at least that one reference design from the plurality of reference designs on the basis of the corrected first index value.

10. The information processing apparatus according to claim 8, wherein
the second index value is defined in units of a plurality of items which pertains to at least one of the attribute, the characteristic and the surrounding environment of the user and is set in such a manner that the second index value which corresponds to one item concerned is more increased for a reference design which is more recommended in a case where one item applies in the plurality of items, and
the processing unit acquires the second index value which corresponds to the item which applies to the attribute, the characteristic or the surrounding environment of the user in execution of the extraction process in the plurality of items.

11. The information processing apparatus according to claim 10, wherein
the attribute contains at least one of the age, the distinction of sex and the residence area.

12. The information processing apparatus according to claim 10, wherein
the characteristic contains at least one of the interest, the taste, the behavioral trend and the past-selected reference designs.

13. The information processing apparatus according to claim 10, wherein
the surrounding environment contains at least one of the temperature, the meteorological condition, the season and the current location.

14. The information processing apparatus according to claim 1, wherein
the target design and the plurality of reference designs pertain to any one of the plurality models of the article, and
the processing unit, in the extraction process,
specifies one reference design which is the same as the target design in the model in the plurality of reference designs and
derives the first index value in regard to the specified reference design.

15. The information processing apparatus according to claim 1, wherein
the processing unit, in the extraction process,
specifies one reference design that the design of a certain component which is included in the plurality of components is the same as the design of the corresponding component of the target design or that the component similarity value of the certain component is more than a reference value relative to the target design in the plurality of reference designs, and
derives the component similarity value which indicates a degree of similarity between the specified design and the target design for each of the plurality of components in regards to each of the plurality of components.

16. The information processing apparatus according to claim 1, wherein
the article is a wristwatch.

17. The information processing apparatus according to claim 1, further comprising:
a storage unit, wherein
the storage unit stores the reference designs in advance.

18. An information processing method which is executed by a computer of an information processing apparatus comprising:
acquiring design data which pertains to a target design of an article which has a plurality of components;
executing an extraction process of extracting at least one reference design from a plurality of reference designs of the article on the basis of the design data; and
making a display unit display information which pertains to at least one reference design which is extracted by the extraction process;
in the extraction process
deriving a component similarity value which indicates a degree of similarity between each of some or all reference designs in the plurality of reference designs and the target design for each of the plurality of components;
deriving a first index value on the basis of a plurality of component similarity values which consist of the component similarity values which are derived for each of the plurality of components; and
extracting the at least one reference design from the plurality of reference designs on the basis of the derived first index value.

19. A non-transitory computer-readable recording medium for recording a program for making a computer of an information processing apparatus realize functions of:
acquiring design data which pertains to a target design of an article which has a plurality of components;
executing an extraction process of extracting at least one reference design from a plurality of the reference designs of the article on the basis of the design data; and
making a display unit display information which pertains to the at least one reference design which is extracted by the extraction process;
in the extraction process deriving a component similarity value which indicates a degree of similarity between each of some or all reference designs in the plurality of reference designs and the target design for each of the plurality of components;
deriving a first index value on the basis of a plurality of component similarity values which consist of the component similarity values which are derived for each of the plurality of components; and
extracting the at least one reference design from the plurality of reference designs on the basis of the derived first index value.
